(19) United States
(12) Patent Application Publication
(10) Pub. No.: US 2026/0241935 A1
(43) Pub. Date: Aug. 20, 2026

(54) Method for Controlling the Slip Value of a Wheel, Control Unit for a Vehicle, and Vehicle

(71) Applicant: Bayerische Motoren Werke Aktiengesellschaft, Muenchen (DE)

(72) Inventor: Florian HUELSMANN, Muenchen (DE)

(21) Appl. No.: 19/489,624

(22) PCT Filed: Aug. 21, 2024
(86) PCT No.: PCT/EP2024/073473

§ 371 Date: Dec. 3, 2025

(30) Foreign Application Priority Data
Sep. 13, 2023 (DE) 10 2023 124 663.1

(51) Int. Cl. B60W 30/18

(52) U.S. Cl. CPC B60W 30/18172; B60W 2520/10; B60W 2520/28; B60W 2720/26

(57) ABSTRACT

A method controls the slip value of a wheel of a vehicle, wherein: a controller is used which outputs a manipulated or correcting variable on the basis of a determined control deviation; the control deviation includes a slip-based component and a rotational-speed-based component; in the case of the slip-based component, the target slip is offset against the actual slip; in the case of the rotational-speed-based component, the slip-based component is offset against a normalization variable dependent on the vehicle speed; and the slip-based component and the rotational-speed-based component are weighted according to slip for the determination of the manipulated or corrected variable.

### BACKGROUND AND SUMMARY

The present invention relates to a method for controlling the slip value of a wheel, to a control unit for a vehicle, and to a vehicle, in particular a motor vehicle.

Slip controllers are typically used in traction control systems of vehicles. DE 195 42 294 B4 discloses, for example, in this context a system for controlling the traction slip in a motor vehicle in which at least one control variable which is dependent on the rotational speeds of the wheels and at least one target value are fed to a controller. It is often difficult to ensure that such controllers work reliably over a wide operating range. Thus, the behavior of the tire changes very considerably at higher slip values. In the case of slip of more than 30%, the longitudinal tire force remains largely constant and independent of the slip. This means that a controller which works reliably at low slip values may reach its limits at higher slip values, or vice versa.

The object of the present invention is therefore to provide a method for controlling the slip value of a wheel of a vehicle, a control unit for a vehicle, and a vehicle, wherein in particular it is intended that a method is supplied which enables reliable control of both low and high slip values.

This object is achieved by a method, a control unit, and by a vehicle, according to the independent claims. Further advantages and features can be found in the dependent claims and the description and the attached figures.

The invention relates to a method for controlling the slip value of a wheel of a vehicle, wherein a controller is used which outputs a correcting variable on the basis of an identified control deviation, wherein the control deviation, also referred to below as “hybrid control deviation”, comprises a slip-based component and a rotational speed-based component, wherein in the case of the slip-based component the target slip is offset against the actual slip, and wherein in the case of the rotational speed-based component the slip-based component is offset against a normalizing variable dependent on the vehicle speed, and wherein the slip-based component and the rotational speed-based component are weighted depending on the slip in order to determine the correcting variable. The term “slip” in the present document always means the (longitudinal tire) slip.

Slip controllers, for example PID slip controllers, are often used in order to implement traction control systems using control technology. They first calculate the actual slip Kist of the wheel to be controlled from its peripheral speed v_{Rad} and the vehicle speed v_{Fzg}:

$${K}_{i s t} = \frac{{v}_{rad} - {v}_{F z g}}{{v}_{F z g}} .$$

A target longitudinal slip Kₛₒₗₗ is additionally calculated taking into account the driving state and other parameters. The difference between the actual slip Kist and the target slip Kₛₒₗₗ is the control deviation e_{K}:

$${e}_{K} = {K}_{i s t} - {K}_{s o l l} .$$

This is used as an input variable of the slip controller, which calculates the drive or braking torque therefrom taking into account other parameters and measurement variables, which is needed to reset the target slip Kₛₒₗₗ at the wheel to be controlled.

The longitudinal force F_{x,Rad} which an automobile or motorcycle tire can transmit is (in addition to the wheel load F_{z,Rad} and the friction value u between the tires and the road) fundamentally determined by the longitudinal slip Kist. The problem here (for tuning a traction control system or a controller) is that the behavior of the tire changes significantly at higher slip values, for example at slip values of K>30%. Beyond these slip values, the longitudinal tire force remains largely constant and independent of the slip. The controlled system then corresponds approximately to a rotating mass with a constant torque offset.

If it is intended that a conventional slip controller resets a high target slip of over 30%, the torque interventions of the controller are too aggressive at low vehicle speeds (the controller vibrates) and too sluggish at high vehicle speeds (the controller can only slowly follow the target slip) because the same rotational speed deviation of the wheel corresponds to a higher slip deviation and hence to a stronger controller intervention at low speeds than at high speeds.

The method according to the invention advantageously makes available a “hybrid” controller which can adjust its operating mode depending on the current longitudinal tire slip Kist steplessly between a pure slip controller and a pure rotational speed controller. A method or a controller is thus advantageously supplied which can operate reliably over a very wide operating range. To do this, the method works with the slip-based component and the rotational speed-based component, wherein the two portions are weighted correspondingly depending on the current slip. This means that the slip-based component is paramount at low slip values and the rotational speed-based component at high slip values.

The weighting of the rotational speed-based component is expediently greater, the higher the actual slip. The situation is thus taken into account in which control is exerted as much as possible based on the rotational speed at higher slip values, whereas control is exerted as much as possible based on the slip at low slip values. A weighting factor is expediently used for the weighting.

It has proven to be advantageous that the weighting of the rotational speed-based component increases linearly with the slip, whereas the weighting of the slip-based component decreases linearly with the slip. The slip here means in particular the amount of the target slip or of the actual slip. According to a preferred embodiment, the rotational speed-based component is, for example, weighted up to slip values of 10 to 20%, in particular for example 15%, with 0 in order then to be weighted, preferably linearly, up to a slip value of approximately 30 to 40%, in particular for example 35%, with 0.9. For this purpose, a corresponding characteristic curve is preferably saved which supplies a corresponding weighting factor depending on the amount of the actual or target slip. The weighting of the slip-based component takes place correspondingly in the opposite fashion. For the (hybrid) control deviation e_{hybr}, this means:

$${e}_{hybr} = {f}_{hybr} * {e}_{K , norm} + ( 1 - {f}_{hybr} ) * {e}_{K} ,$$

wherein e_{K} is the (conventional) slip control deviation, e_{K,norm} is the speed control deviation, and f_{hybr} is weighting factor. The slip control deviation constitutes the slip-based component, and the speed control deviation constitutes the speed-based component.

The slip control deviation ex is, as already mentioned, calculated as follows:

$${e}_{K} = {K}_{i s t} - {K}_{s o l l} .$$

The offsetting of the normalizing variable dependent on the vehicle speed is preferably effected by multiplying the normalizing variable by the slip-based component. The rotational speed control deviation e_{K, norm}, which is also referred to as the normalized control deviation, is thus calculated as follows:

$${e}_{K , norm} = {f}_{K , norm} * {e}_{K} ,$$

wherein f_{K,norm} is the normalizing variable dependent on the vehicle speed.

The normalizing variable expediently comprises the vehicle speed v_{Fzg} and a constant vₙₒᵣₘ. The constant is preferably the denominator and the vehicle speed the numerator:

$${f}_{K , norm} = \frac{{v}_{F z g}}{{ν}_{n o r m}} .$$

In particular, the form of the normalizing variable in the present case enables the functionality of the method:

$${K}_{s o l l , n o r m} = {f}_{K , norm} * {K}_{s o l l} \\ {K}_{ist , norm} = {f}_{K , norm} * {K}_{ist} = \frac{{v}_{r a d} - {v}_{F z g}}{{ν}_{n o r m}} \\ {e}_{K , norm} = {K}_{i s t , n o r m} - {K}_{s o l l , n o r m} = \frac{{ν}_{r a d} - ( 1 + {K}_{s o l l} ) {v}_{F z g}}{{v}_{n o r m}} \\ {v}_{r a d} = {r}_{r a d} * {ω}_{i s t} \\ ( 1 + {K}_{s o l l} ) {v}_{F z g} = {r}_{r a d} * {ω}_{Rad , soll} \\ {e}_{K , nor𝔪} = \frac{{r}_{r a d}}{{v}_{n o r m}} * ( {ω}_{i s t} - {ω}_{s o l l} )$$

With the rolling radius r′Rad and the actual and target wheel angle speeds ωᵢₛₜ and ωₛₒₗₗ, the rotational speed control deviation or “normalized control deviation” e_{K,norm} thus exactly reflects the behavior of a rotational speed control system.

It has been shown that the constant is preferably, for example, in the double-digit range. The constant Vorm which expediently is in the units [km/h] is, for example, within a range from 40 to 50, depending on the vehicle, but also below or above this range.

The subject of the invention is also a control unit for a vehicle, in particular a motor vehicle, comprising a calculating unit which is parameterized and/or designed to perform the method.

The method is preferably implemented in the form of a controller, preferably in the form of a PID controller (PID, proportional-integral-differential controller). The functionality can advantageously be easily implemented in existing traction control systems because only the calculation of the control deviation has to be augmented. Accordingly, only the constant vₙₒᵣₘ and the weighting f_{hybr} need to be applied for the controller.

The subject of the invention is also a vehicle, in particular a motor vehicle, comprising a control unit according to the invention. Motor vehicles of the type in question are in particular land vehicles, such as cars or in particular motorized two-wheelers, such as motor scooters or motorcycles, powered either electrically or by an internal combustion engine.

Such a method or a controller designed in this fashion are capable of optimally resetting the slip in the whole slip range. In particular, a (very high) target slip can thus be reset. Expediently enhanced customer functions can thus be constituted in which a high braking or traction slip is desired.

Further advantages and features can be found in the following description of the method with reference to the attached figures.

### BRIEF DESCRIPTION OF THE DRAWINGS

FIG. 1 shows the longitudinal tire force as a function of the longitudinal tire slip; and

FIG. 2 shows the weighting factor as a function of the slip.

### DETAILED DESCRIPTION OF THE DRAWINGS

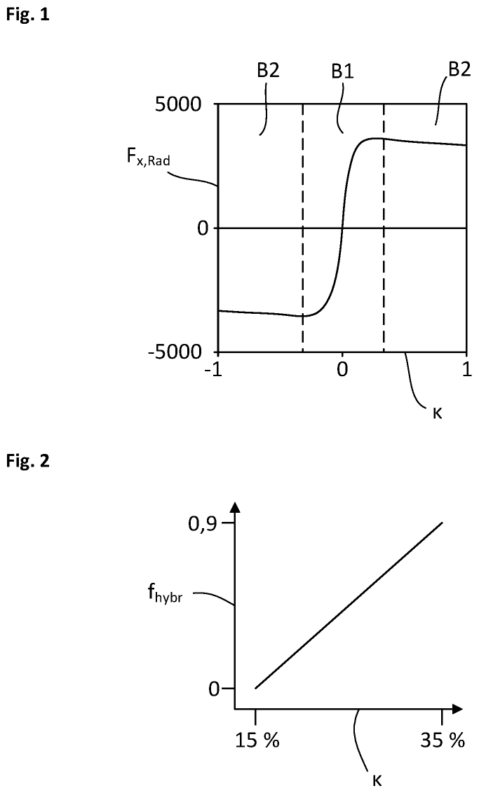

FIG. 1 shows in a diagram the longitudinal tire force F_{x,Rad} as a function of the longitudinal tire slip K. It is clear from the diagram that the behavior of the tire changes significantly at higher slip values beyond approximately K>30%. The longitudinal tire force is then largely constant and independent of the slip. Whilst in the range B1, a slip controller is advantageous which calculates the control deviation from the difference between the actual and target slip, in the working ranges B2 a rotational speed controller is desirable which calculates the control deviation from the difference between the actual and target rotational speed.

The method advantageously enables control which can be adjusted depending on the current longitudinal tire slip steplessly between the operation of a pure slip controller and a pure speed controller. Specifically, the control deviation which is the input variable of the controller is calculated such that the same controller works optimally both in low and high slip ranges and the method works optimally both in low and high slip ranges.

FIG. 2 shows the weighting factor f_{hybr} as a function of the longitudinal tire slip K. The weighting factor f_{hybr} can be calculated, for example, with the aid of a characteristic curve, as drawn in FIG. 2, as a function of the amount of the actual or target slip. A method for controlling the slip value of a wheel of a vehicle can thus be supplied which functions optimally in the whole slip range.

### LIST OF REFERENCE SIGNS

B1 slip controller working range
B2 rotational speed controller working range
F_{x,Rad} longitudinal force
K slip
f_{hybr} weighting factor

1.-9. (canceled)

10. A method for controlling a slip value, the method comprising:
outputting, via a controller, a correcting variable for the slip value of a wheel of a vehicle based on an identified control deviation,
wherein the control deviation comprises a slip-based component and a rotational speed-based component,
wherein, in the case of the slip-based component, a target slip is offset against actual slip,
wherein, in the case of the rotational speed-based component, the slip-based component is offset against a normalizing variable dependent on vehicle speed, and
wherein the slip-based component and the rotational speed-based component are weighted depending on slip in order to determine the correcting variable.

11. The method according to claim 10, wherein
the weighting of the rotational speed-based component is greater, the higher the actual slip or the target slip.

12. The method according to claim 10, wherein
the weighting of the rotational speed-based component increases linearly with the slip, and
the weighting of the slip-based component decreases linearly with the slip.

13. The method according to claim 10, wherein,
in order to determine the rotational speed-based component, the slip-based component is multiplied by the normalizing variable.

14. The method according to claim 10, wherein the normalizing variable comprises the vehicle speed and a constant.

15. The method according to claim 14, wherein the constant is the denominator and the vehicle speed is the numerator.

16. The method according to claim 14, wherein the constant is in a mid-double-digit range.

17. A control unit for a vehicle, comprising:
a calculating unit which is parameterized and/or designed to carry out acts of:
outputting a correcting variable for the slip value for a wheel of a vehicle based on an identified control deviation,
wherein the control deviation comprises a slip-based component and a rotational speed-based component,
wherein, in the case of the slip-based component, a target slip is offset against actual slip,
wherein, in the case of the rotational speed-based component, the slip-based component is offset against a normalizing variable dependent on vehicle speed, and
wherein the slip-based component and the rotational speed-based component are weighted depending on slip in order to determine the correcting variable.

18. A vehicle comprising a control unit according to claim 17.
